(19) United States
(12) Patent Application Publication
(10) Pub. No.: US 2006/0202458 A1
(43) Pub. Date: Sep. 14, 2006

(54) Gas bag

(75) Inventor: Hans-Joachim Tietze, Heubach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Gmbh

(21) Appl. No.: 11/374,914

(22) Filed: Mar. 14, 2006

(30) Foreign Application Priority Data
Mar. 14, 2005 (DE) 10 2005 011 641.8

(51) Int. Cl. B60R 21/16

(52) U.S. Cl. 280/743.1

(57) ABSTRACT

The invention relates to a gas bag (3) for an occupant restraint arrangement in vehicles, having a first and a second fabric layer (5, 6) which lie opposite each other and are permanently connected with each other in at least one fabric section (7, 21, 23, 25, 27, 37, 39) by interweaving in one piece, and having sacrificial threads (43) which are arranged close to the fabric section (7, 21, 23, 25, 27, 37, 39) and which tear in the case of restraint, characterized in that the sacrificial threads (43) are respectively formed by a thread (29, 30) which emerges from the first fabric layer (5) and enters into the second fabric layer (6) with the formation of a freely floating thread section (47) between the fabric layers (5, 6).

### TECHNICAL FIELD

The invention relates to a gas bag for an occupant restraint system in vehicles, comprising a first and a second ply of fabric opposing each other and being durably connected with each other in at least one fabric section by integrated interweaving, the first and second plies of fabric further having sacrificial threads which are arranged close to the fabric section and which burst in a restraint situation.

### BACKGROUND OF THE INVENTION

A gas bag of the afore-mentioned type is known for example from DE 299 16 700 U1, which is herewith included by reference.

In the known head-side gas bag which extends from the A-column of a vehicle up to the C-column, the peripheral edges of the plies of the fabric are durably connected with each other by integral interweaving. In addition, the gas bag volume is divided by partition walls into several chambers which can be inflated at different speeds. The partition walls are likewise formed by integral interweaving the plies of fabric which lie opposite each other. Close to the partition walls or the peripheral edge, the plies of fabric are connected with each other in small punctiform or linear areas by integrally interweaving at least one warp thread and/or weft thread such that this thread forms a sacrificial thread which bursts in a restraint situation whilst the gas bag is in operation. The sacrificial threads are destroyed owing to the internal pressure in the gas bag during inflation, whilst the occupant who is to be protected dives into the gas bag, or already during unfolding. In this way, a simple adaptation of the gas bag geometry, of the flow conditions inside the gas bag, and a reduction to the thread stress is to be achieved in the permanently interwoven sections.

The threads in the permanently interwoven sections of the plies of fabric are, however, already exposed to very high stresses upon the first pressure surge during inflation or when the vehicle occupant strikes onto the inflated gas bag. The warp threads or weft threads, which are interwoven together in a punctiform manner before the interwoven fabric sections, i.e. the peripheral edges or the partition walls, in this case only offer a limited protection. When these warp threads or weft threads tear, holes appear in addition in the outer airbag wall, such that the restraining effect of the gas bag may be adversely affected.

### SUMMARY OF THE INVENTION

By comparison, the invention provides a gas bag in which an improved protection of the gas bag fabric is achieved by simple and favourably-priced measures in the fabric sections which are integrally interwoven with each other, in particular the partition walls and the peripheral edges, when load peaks occur, and at the same time the risk of damage to the outer gas bag wall is reduced. In accordance with the invention, a gas bag is provided for an occupant restraint system in vehicles, comprising a first and a second ply of fabric opposing each other and being durably connected with each other in at least one fabric section by integral interweaving. The first and second plies of fabric further comprise sacrificial threads which are arranged close to the fabric section and which burst in a restraint situation. Each of the sacrificial threads is formed by a thread which emerges from the first ply of fabric and enters into the second ply of fabric thereby forming a thread section which is freely floating between the fabric plies.

The opposing plies of fabric are interwoven with the sacrificial threads of the gas bag according to the invention in an area close to the partition walls or to the peripheral edges such that whilst the gas bag is being inflated, initially a defined distance can exist between the fabric plies. This is achieved in that the sacrificial threads have a thread slack in the form of a freely floating thread section between the fabric plies. The freely floating sacrificial threads can be produced by a weaving technique in a simple manner in that individual warp threads or weft threads emerge from their ply of fabric at a predetermined site and are transferred into the opposite ply of fabric. Through this weaving technique, a “free” thread length can therefore form in the gas bag volume between the two fabric plies, which is not associated with either of the fabric plies, whilst the warp threads or weft threads form an integral component of the fabric layers up to their emerging from the first fabric ply and after their entry into the second fabric ply. The length of the freely floating thread section which is thus formed can be defined precisely by a corresponding coordination of the exit- and entry points into the respective fabric layers and the thread guidance. It is also possible thereby to form the sacrificial threads with a graduated free thread length, whereby an equalizing can be achieved of several load peaks which occur in succession. As the burst site generally occurs in the centre of the freely floating thread section owing to the stress of the threads by such load peaks, in addition no holes form in the associated fabric layers. In contrast to the warp threads or weft threads of the gas bag known from the prior art, which are connected with each other in a punctiform manner, the sacrificial threads, which are formed according to the invention with a freely floating thread section, also do not impede the gas flow in the gas bag. As no additional constituents or components, but rather merely changes in process technique are necessary for the production of the sacrificial threads with the freely floating thread section, the gas bag according to the invention can also be produced at a particularly favourable cost. Therefore, the formation of the freely floating thread sections can take place for example by the insertion of spacers between the fabric layers during the weaving process.

In a particularly preferred embodiment of the invention, the freely floating thread sections of the sacrificial threads are constructed so as to be of different length. Hereby, a particularly good protection of the threads is achieved in the fabric sections which are interwoven durably with each other at different or successive load peaks. It is quite especially preferred when the length of the freely floating thread sections decreases in the direction of the interwoven fabric section which is to be protected. Thereby, the stressing of the threads in the interwoven fabric section can be decreased gradually and in line with a specific objective.

According to the invention, the section of the fabric layer which is durably and integrally interwoven permanently together may be part of a partition wall or a peripheral edge or rim. In particular, the sacrificial threads with the freely floating thread section can be arranged in front of the regions of the partition wall or of the peripheral edges which lie downstream of a main flow direction of the gas which is entering into the gas bag, and therefore are exposed to particularly high stresses. Usually, the end sections of the partition walls are surrounded by the sacrificial threads with the freely floating thread sections, because in this region the risk of damage to the fabric layers that are interwoven together is at its greatest.

Finally, the thread thickness of the sacrificial threads in the freely floating thread section can be selected such that a predetermined tensile strength of the sacrificial thread is set and the thread shows an approximately elastic behaviour up to the tear. By this simple measure, stresses of the threads in the interwoven fabric section can also be readily taken up below the load peaks leading to the tearing of the sacrificial threads.

### BRIEF DESCRIPTION OF THE DRAWINGS

FIG. 1 shows a diagrammatic side view of the gas bag according to the invention in the form of a large-are ABC gas bag;

FIG. 2 shows an enlarged view of an integrally interwoven fabric section and sacrificial threads arranged in the vicinity of the fabric section, in top view; and

FIG. 3 shows a sectional view of the fabric section of FIG. 2.

### DETAILED DESCRIPTION OF PREFERRED EMBODIMENT

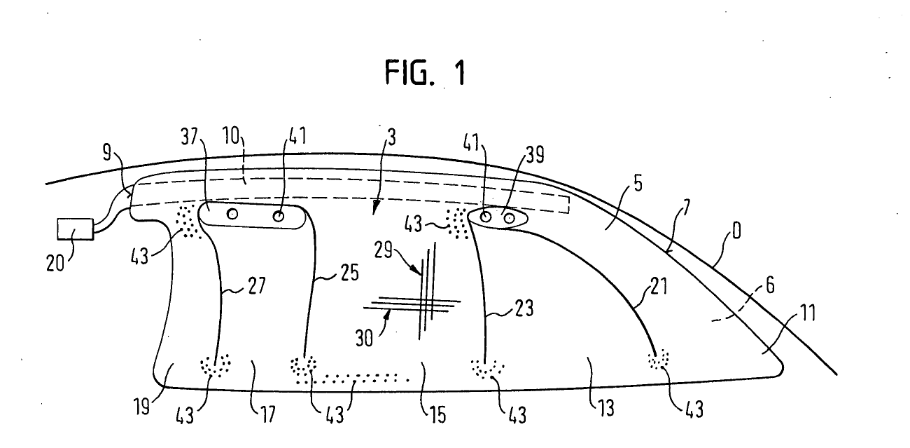

In FIG. 1, a gas bag protection device is illustrated, having a large area ABC gas bag 3 in the inflated condition, which in the case of an accident completely covers the side windows on one side of a vehicle, and acts as head protection for the front and the rear passengers. The roof frame of the vehicle is designated by D. The gas bag 3 is formed from two opposing plies of fabric which are designated by the reference numbers 5 and 6, the lower fabric ply 6 being covered by the upper fabric ply 5 in FIG. 1. The two plies of fabric 5, 6 are integrally interwoven with each other along the rim or peripheral edge 7, using the Jaquard weaving method. The fabric layers each consist of warp and weft threads 29 and 30 respectively, the alignment of these threads which can be seen from FIG. 1 in longitudinal and vertical direction of the gas bag body being purely by way of example and not therefore being restricted to the alignment which is shown.

A gas lance 10 is inserted via an opening 9 on the upper edge of the gas bag 3, which lance 10 is only illustrated with broken lines because it is not part of the gas bag. Gas is introduced via the gas lance 10 in the region of the entire upper edge of the gas bag, into the latter. The gas bag 3 has several chambers 11, 13, 15, 17 and 19 which are filled with gas from a gas generator 20. The chambers are separated from each other by partition walls 21, 23, 25 and 27. The partition walls 21 to 27 do not represent separate parts, but rather are likewise formed by integrally interweaving the plies of fabric 5, 6.

Two fabric sections 37 and 39 which are durably connected with each other by integrally interweaving and which surround passage openings 41 are additionally provided immediately adjoining the gas lance 10. The gas bag 3 can be fastened to the roof frame D by means of fastening screws, not illustrated here, which are guided through the passage openings 41.

Sacrificial threads 43, which are illustrated by dots in FIG. 1, are arranged in the vicinity of the partition walls 21 to 27, and also close to the peripheral edge 7. The sacrificial threads 43 are situated in a substantially ring-shaped region around the lower ends of the partition walls 21 to 27 in FIG. 1, and also in front of an upper region of the partition walls 23 and 27 in FIG. 1, which continue into the fabric sections 37 and 39 and which are arranged downstream of the main flow direction of the gas which is flowing out from the gas lance. In addition, sacrificial threads 43 which are arranged substantially in a linear form, are provided in front of the peripheral edge 7 in the region of the chamber 15, as the chamber 15 has a large area and is filled particularly quickly owing to the flow conditions in the gas bag. Therefore, high stresses on the durably interwoven fabric section in the peripheral edge 7 are to be expected in the region of this chamber upon the inflating of the gas bag.

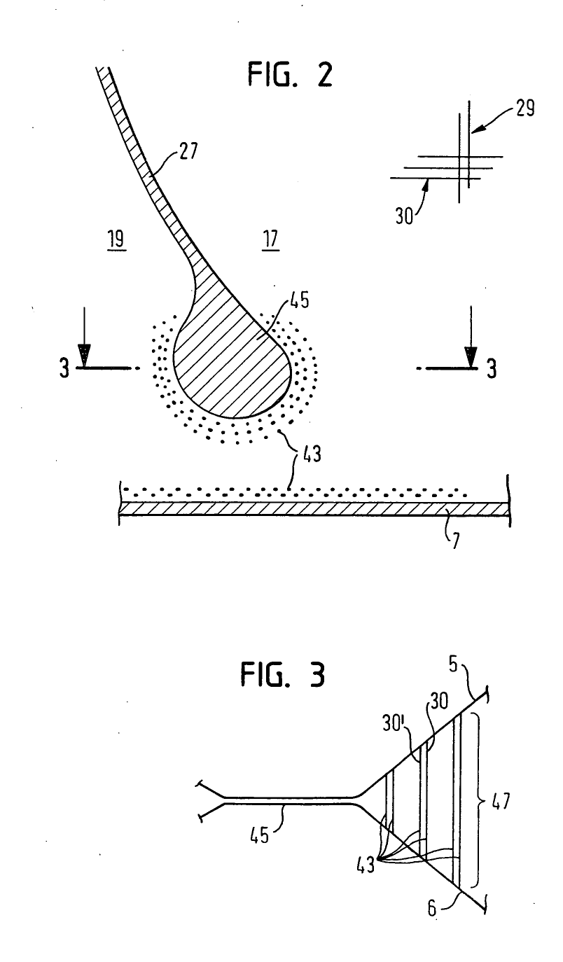

The arrangement and construction of the sacrificial threads 43 is illustrated in further detail in FIGS. 2 and 3.

FIG. 2 shows a cut-out of the chambers 17 and 19 with the partition wall 27 which is widened at its lower end 45 and is thereby strengthened. The partition wall 27 and the lower end 45 are formed by the interweaving in a single piece of a section of the upper fabric ply 5 and of the lower fabric ply 6 (FIG. 1). The lower end 45 of the partition wall 27 ends at a distance from the peripheral edge 7 such that gas can overflow from the chamber 19 into the chamber 17 of the gas bag 3. Usually, very high stresses of the fabric sections which are interwoven with each other occur at the passage from the chamber 19 to the chamber 17 between the lower end 45 of the partition wall 27 and the peripheral edge 7. Therefore, sacrificial threads 43 are provided in accordance with the invention, which are arranged approximately in a ring shape around the lower end 45 of the partition wall 27, and also run in an approximately linear form along a portion of the peripheral edge 7. The alignment of the warp threads and weft threads 29, 30 in the plies of fabric 5, 6 is indicated by way of example as in FIG. 1.

It can be seen from FIG. 3 that the sacrificial threads 43 are formed respectively from an individual weft thread 30, 30′ of the upper fabric ply 5 or of the lower fabric ply 6, which emerges from the respective fabric layer and enters into the respectively opposite fabric layer, forming a freely floating thread section 47 running in the gas bag volume between the plies of fabric 5 and 6. The distance between the exit point of the weft thread 30 from the upper fabric ply 5 and the entry point of the weft thread 30′ coming from the lower fabric ply 6 into the upper fabric ply 5 is selected such that as little thread loss as possible occurs in the fabric layer and the fabric layer thereby maintains its tightness. The same applies to the entry and exit points of the weft threads 30, 30′ into or out from the lower fabric ply 6. If necessary, however, a foil may also be provided which is applied onto the plies of fabric from the exterior in the region of the sacrificial threads, in order to ensure the tightness of the gas bag fabric in this region.

It can be seen in addition in FIG. 3 that the length of the free thread section 47 of the sacrificial threads 43 decreases in the direction of the integrally interwoven fabric section at the lower end 45 of the partition wall 27. Through this graduated formation of the length of the free thread sections 47, the energy acting on the threads in the fabric section arranged behind the sacrificial threads, for example in the lower end 45 of the partition wall 27 or in the peripheral edge 7, can be decreased gradually. Hereby, an effective protection is achieved of the interwoven fabric sections against the pressure peaks occurring in succession in the gas bag volume upon inflating of the gas bag and as the vehicle occupant dives into the gas bag.

In addition, a predetermined tensile strength and a substantially elastic behaviour up to the tearing of the sacrificial threads by exceeding the tensile strength can be set through the selection of the thread strength of the sacrificial threads 43 in the freely floating thread section 47. Through this measure, an additional decrease of energy is already achieved before the bursting of the sacrificial threads.

Instead of the weft threads 30, the warp threads 29 can also serve as sacrificial threads. As the freely floating thread section 47 of the sacrificial threads 43 allows a distance of the fabric plies 5, 6 from each other, the individual sacrificial threads do not impede the flow within the gas bag. The gas can flow through between the individual, freely floating thread sections 47 of the sacrificial threads 43 and lead to a rapid unfolding of the gas bag 3.

In a restraint situation, the gas generator 20 is activated via an acceleration sensor arranged in the vehicle, and gas is passed to the gas bag 3 via the gas lance 10. In the gas bag shown in FIG. 1, the gas firstly fills the chambers 11, 15 and 19, because the shortest flow connection exists to these chambers. In addition, the gas is guided along the partition walls 21, 23, 25 and 27 and can enter into the chambers 13 and 17 via the flow connections existing between the chambers 11, 15 and 19 on the one hand and the chambers 13 and 17 on the other hand, until the gas bag is fully unfolded and inflated.

With this inflating and unfolding process, high tensile stresses occur in particular in the lower regions of the partition walls 21 to 27 which lie on the flow passage between the chambers 11 to 19. These tensile stresses are efficiently decreased by the sacrificial threads 43 which are arranged approximately in a ring shape around the corresponding sections of the partition walls 21 to 27. The sacrificial threads 43 offer a resistance against the unfolding of the gas bag 3 and hence the distancing of the fabric plies 5 and 6 from each other, such that the stress occurring during this process can not act directly on the sections of the partition walls 21 to 27 that are interwoven with each other. At the same time, a greater or lesser elastic expansion occurs of the free thread sections 47, whereby energy is decreased. On exceeding the tensile strength of the free thread section 47 of the sacrificial threads 43, the latter burst with the tear site generally occurring in the middle of the free thread section 47. Through the gradually decreasing length of the free thread section 47 of the sacrificial threads 43 in the direction of the fabric sections which are interwoven with each other in one piece, e.g. the partition walls 21 to 27, the stress acting on the threads is also gradually decreased. This means that the thread sections 47 the furthest distance away from the interwoven fabric section burst before the thread sections which are arranged closer, such that these thread sections 47 which are arranged closer are retained after the decrease of a first load peak. When a further load peak occurs, for example when the vehicle occupant dives into the gas bag 3, these sacrificial threads 43 that are still intact can efficiently protect the interwoven fabric section. In addition, the tensile strength can be influenced by the thread thickness of the free thread section 47 and hence an approximately elastic behaviour of the sacrificial threads 43 can be set during the inflation process and in addition energy can be decreased.

1. A gas bag adapted for use in an occupant restraint system for vehicles, the gas bag comprising
a first and second ply of fabric opposing each other and being permanently connected with each other by integral interweaving in at least one fabric section, the first and second plies of fabric further having sacrificial threads arranged close to the fabric section, the sacrificial threads bursting in a restraint situation;
wherein each of the sacrificial threads comprise a thread which emerges from the first ply of fabric and enters into the second fabric layer (6) and has a freely floating thread section arranged between the first and second ply of fabric.

2. The gas bag according to claim 1, characterized in that the freely floating thread sections of the sacrificial threads are of differing length.

3. The gas bag according to claim 2, characterized in that the length of the freely floating thread section of the sacrificial threads decreases in the direction of the fabric section.

4. The gas bag according to claim 1, characterized in that the fabric section is a part of a partition wall.

5. The gas bag according to claim 1, characterized in that the freely floating thread section of the sacrificial threads has a predetermined tensile strength and in said restraint situation, shows an approximately elastic behavior up to reaching the predetermined tensile strength.

6. The gas bag according to claim 1, characterized in that the gas bag (3) is a large-area side gas bag.
